(19) United States
(12) Patent Application Publication
(10) Pub. No.: US 2026/0126875 A1
(43) Pub. Date: May 7, 2026

(54) SENSOR CONTROLLER, ELECTRONIC APPARATUS, AND POSITION DETECTION METHOD

(71) Applicant: Wacom Co., Ltd., Saitama (JP)

(72) Inventors: Yoshio NOMURA, Saitama (JP); Masayuki MIYAMOTO, Saitama (JP)

(73) Assignee: Wacom Co., Ltd., Saitama (JP)

(21) Appl. No.: 19/436,804

(22) Filed: Dec. 30, 2025

Related U.S. Application Data
(63) Continuation of application No. PCT/JP2024/019976, filed on May 31, 2024.

(30) Foreign Application Priority Data
Jul. 18, 2023 (JP) 2023-117016

(51) Int. Cl. G06F 3/041; G06F 3/044

(52) U.S. Cl. CPC G06F 3/041661; G06F 3/0441; G06F 3/0442; G06F 2203/04106

(57) ABSTRACT

A sensor controller is provided, which is configured to be connected to a capacitive touch sensor having a plurality of sensor electrodes arranged planarly. The sensor controller includes a scan controller that executes a plurality of types of operation modes in which a pen scan for detecting an active pen transmitting a downlink signal and a touch scan for detecting a passive pointer not transmitting the downlink signal are repeatedly executed on a time-sharing basis via the plurality of sensor electrodes. The sensor controller includes a signal transmitter that transmits, during execution of the pen scan, an uplink signal for requesting the downlink signal via the plurality of sensor electrodes. When the passive pointer is not detected by the touch scan, the signal transmitter makes a transmission frequency of the uplink signal lower than when the passive pointer is detected by the touch scan.

### BACKGROUND

### Technical Field

The present disclosure relates to a sensor controller, an electronic apparatus, and a position detection method.

### Description of the Related Art

Conventionally, there have been known position detection systems each including an active electronic pen (also simply referred to as an “active pen” hereunder), which is a position indicator with a built-in battery, and an electronic device having a touch sensor. In this type of system, two types of signals are transmitted and received between the active pen and the electronic device so as to synchronize data exchanges and controls therebetween. Of the two distinct types of signals, one from the electronic device is called an “uplink signal,” and the other from the active pen is called a “downlink signal.”

JP2021/043640 discloses a touch controller operating in an uplink power-saving mode and a normal mode. Upon receipt of a suspend instruction from a host computer, the touch controller operates in the uplink power-saving mode in which power is saved for transmitting the uplink signal. Upon detecting a predetermined trigger while operating in the uplink power-saving mode, the touch controller returns to the normal mode.

However, the touch controller disclosed in JP2021/043640 fails to transition from the normal mode to the power-saving mode in a case where the host computer is for some reason unable to transmit the suspend instruction.

### BRIEF SUMMARY

The present disclosure has been made in view of the above circumstances and provides, as an object, a sensor controller, an electronic device, and a position detection method for spontaneously saving power in detecting a pointed position, in accordance with detection conditions of a touch sensor.

According to a first aspect of the present disclosure, there is provided a sensor controller connected to a capacitive touch sensor having a plurality of sensor electrodes arranged planarly. The sensor controller includes a scan controller that executes a plurality of types of operation modes. In those operation modes, a pen scan for detecting an active pen transmitting a downlink signal and a touch scan for detecting a passive pointer not transmitting the downlink signal are repeatedly executed on a time-sharing basis via the plurality of sensor electrodes and a signal transmitter transmits, during execution of the pen scan, an uplink signal for requesting the downlink signal, via the plurality of sensor electrodes. When the passive pointer is not detected by the touch scan, the signal transmitter makes a transmission frequency of the uplink signal lower than when the passive pointer is detected by the touch scan.

According to a second aspect of the present disclosure, there is provided an electronic device including a capacitive touch sensor having a plurality of sensor electrodes arranged planarly and a sensor controller connected to the above-mentioned touch sensor.

According to a third aspect of the present disclosure, there is provided a position detection method using a sensor controller connected to a capacitive touch sensor having a plurality of sensor electrodes arranged planarly. The position detection method includes, by the sensor controller, repeatedly executing, on a time-sharing basis via the plurality of sensor electrodes, a pen scan for detecting an active pen transmitting a downlink signal and a touch scan for detecting a passive pointer not transmitting the downlink signal as well as transmitting, during execution of the pen scan, an uplink signal for requesting the downlink signal, via the plurality of sensor electrodes. In the transmitting, when the passive pointer is not detected by the touch scan, a transmission frequency of the uplink signal is made lower than when the passive pointer is detected by the touch scan.

According to a fourth aspect of the present disclosure, there is provided a sensor controller connected to a capacitive touch sensor having a plurality of sensor electrodes arranged planarly. The sensor controller includes a detection processor that repeatedly executes a touch scan for detecting a passive pointer not transmitting any signal via the plurality of sensor electrodes, The touch scan includes a specific drive operation and a drive change circuitry that changes a drive parameter related to the specific drive operation in such a manner that, when the passive pointer is not detected by the touch scan, either an execution frequency of the specific drive operation is made lower or an execution amount of the specific drive operation is made smaller than when the passive pointer is detected by the touch scan.

According to a fifth aspect of the present disclosure, there is provided an electronic device including a capacitive touch sensor having a plurality of sensor electrodes arranged planarly and a sensor controller connected to the above-mentioned touch sensor.

According to a sixth aspect of the present disclosure, there is provided a position detection method using a sensor controller connected to a capacitive touch sensor having a plurality of sensor electrodes arranged planarly. The position detection method includes, by the sensor controller, repeatedly executing a touch scan for detecting a passive pointer not transmitting any signal via the plurality of sensor electrodes. The touch scan includes a specific drive operation and changes a drive parameter related to the specific drive operation in such a manner that, when the passive pointer is not detected by the touch scan, either an execution frequency of the specific drive operation is made lower or an execution amount of the specific drive operation is made smaller than when the passive pointer is detected by the touch scan.

According to the present disclosure, it is thus possible to spontaneously save power in detecting the pointed position, in accordance with the detected state of the touch sensor.

### BRIEF DESCRIPTION OF THE SEVERAL VIEWS OF THE DRAWINGS

FIG. 1 is an overall configuration diagram of a position detection system incorporating an electronic device common to embodiments of the present disclosure;

FIG. 2 is a view depicting an exemplary internal configuration of the electronic device in FIG. 1;

FIG. 3 is a functional block diagram of a sensor controller in a first embodiment of this disclosure;

FIG. 4 is a flowchart of an exemplary detection operation performed by the sensor controller in FIG. 3;

FIG. 5 is a detailed flowchart regarding a first mode and a second mode (steps SP18 and SP20) in FIG. 4;

FIG. 6 is a view indicating exemplary operation modes for the sensor controller;

FIG. 7 is a time chart regarding transmission of an uplink signal;

FIG. 8 is a tabular view indicating exemplary settings regarding transmission of the uplink signal or reception of a downlink signal;

FIG. 9 is a flowchart regarding a first modification of the first embodiment;

FIG. 10 is a detailed flowchart regarding a second modification of the first embodiment;

FIG. 11 is a functional block diagram of a sensor controller in a second embodiment of this disclosure;

FIG. 12 is a view schematically depicting a method of detecting a touch by use of orthogonal code sequences;

FIG. 13 is a flowchart of an example of the detection operation performed by the sensor controller in FIG. 11;

FIG. 14 is a view schematically depicting a drive operation of the sensor controller in a state where a touch is not detected;

FIG. 15 is a view schematically depicting drive operations of the sensor controller in a state where a touch is detected;

FIG. 16 is a view depicting a first example regarding differences in behavior between a first drive operation and a second drive operation;

FIG. 17 is a view depicting a second example regarding the differences in behavior between the first drive operation and the second drive operation;

FIG. 18 is a view depicting a third example regarding the differences in behavior between the first drive operation and the second drive operation; and

FIG. 19 is a flowchart of another example of the detection operation performed by the sensor controller in FIG. 11.

### DETAILED DESCRIPTION

A sensor controller, an electronic device, and a position detection method according to the present disclosure will be described below with reference to the accompanying drawings. It is to be noted that the present disclosure is not limited to the embodiments and modifications thereof to be discussed below and that such embodiments and modifications may be modified as needed within the spirit and scope of this disclosure. The configurations of the embodiments and modifications thereof may be combined as desired provided there is no technical conflict therebetween. The steps constituting the flowcharts may or may not be performed individually or may be executed in different sequences provided there is no technical conflict therebetween.

### Explanation of Position Detection System 10

### Overall Configuration

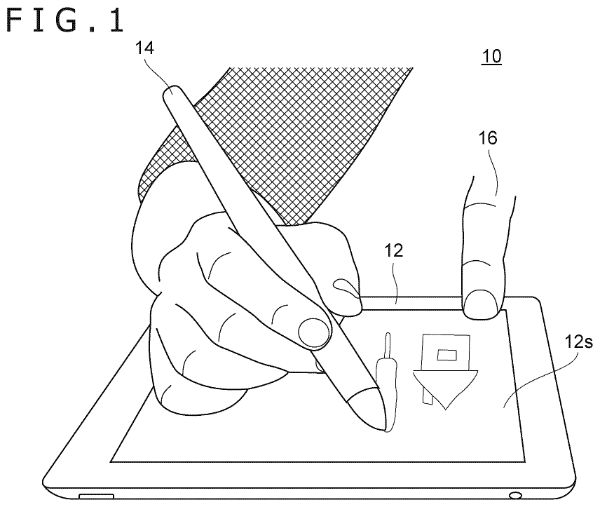

FIG. 1 is an overall configuration diagram of a position detection system 10 incorporating an electronic device 12 common to embodiments of the present disclosure. The position detection system 10 includes the electronic device 12 and an electronic pen 14 (corresponding to an “active pen”) used in combination with the electronic device 12.

The electronic device 12 may be a tablet terminal with or without a display function, a smartphone, or a personal computer, for example. In a case where the electronic device 12 is a liquid crystal display tablet, a user may hold the electronic pen 14 by one hand and move it while pressing a pen tip onto a touch surface 12s to write pictures and letters on the electronic device 12. The user may also bring his/her finger 16 (corresponding to a “passive pointer”) into contact with the touch surface 12s to perform desired operations through user controls being displayed.

The electronic pen 14 is a pen-type pointing device and configured to be bidirectionally communicable with the electronic device 12. In the description that follows, a signal transmitted from the electronic device 12 to the electronic pen 14 will be referred to as an “uplink signal,” and a signal transmitted from the electronic pen 14 to the electronic device 12 will be referred to as a “downlink signal.” It is to be noted that the electronic pen 14 is an “active type” stylus that actively generates a signal from electric energy accumulated inside and that transmits the generated signal as the downlink signal to the electronic device 12.

### Circuit Configuration of Sensor Controller 22

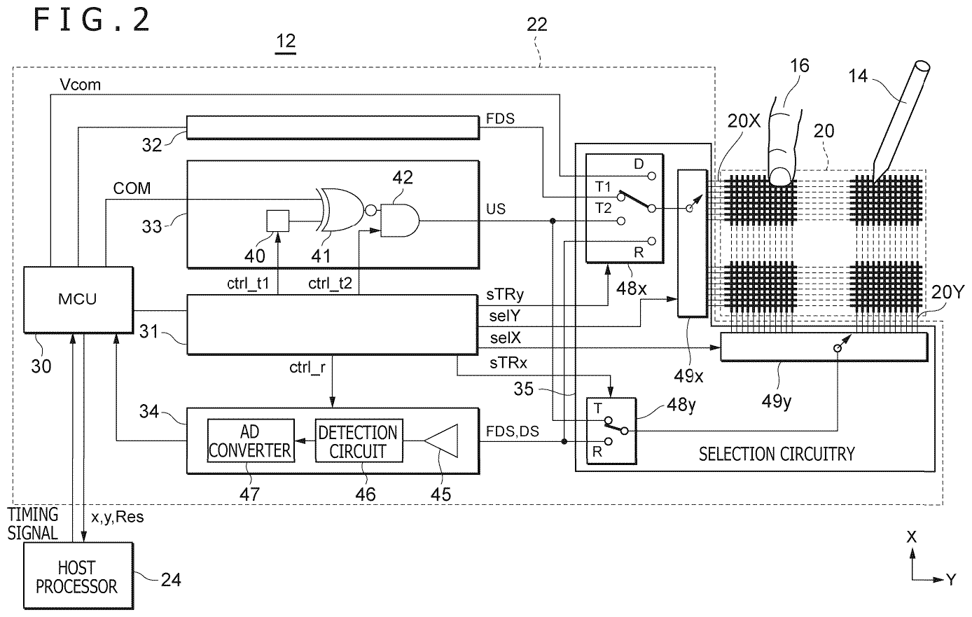

FIG. 2 is a view depicting an exemplary internal configuration of the electronic device 12 in FIG. 1. The electronic device 12 includes a touch sensor 20, a sensor controller 22, and a host processor 24.

The touch sensor 20 is a capacitive (more specifically, mutual capacitance) sensor that has a plurality of sensor electrodes 20X and 20Y arranged planarly. The touch sensor 20 includes a plurality of sensor electrodes 20X for detecting positions in an X direction (X coordinates) and a plurality of sensor electrodes 20Y for detecting positions in a Y direction (Y coordinates). The sensor electrodes 20X and 20Y may be constituted by a wire mesh or a transparent conductive material that includes indium tin oxide (ITO). The sensor electrodes 20X and 20Y are insulated from one another by an insulating substrate (not depicted), which includes glass or resin, interposed therebetween.

The linear sensor electrodes 20X extend in the Y direction and are spaced at equal distances apart in the X direction. The linear sensor electrodes 20Y extend in the X direction and are spaced at equal distances apart in the Y direction. It is to be noted that, in place of the above-mentioned mutual capacitance sensor, the touch sensor 20 may be a self-capacitance sensor that has block-type electrodes arranged in a two-dimensional grid pattern. As another alterative, the touch sensor 20 may be a “built-in” (more specifically, on-cell or in-cell) sensor formed integrally with a display panel, which is not depicted. As a further alternative, the touch sensor 20 may be an “external” (or out-cell) sensor attached externally to the display panel.

The sensor controller 22 is connected to the touch sensor 20 and includes a micro-control unit (MCU) 30, a logic circuitry 31, a first transmitter 32, a second transmitter 33, a reception circuitry 34, and a selection circuitry 35.

The MCU 30 and the logic circuitry 31 control the transmission and reception operations of the sensor controller 22 by controlling the first transmitter 32, the second transmitter 33, the reception circuitry 34, and the selection circuitry 35. The MCU 30 is a control unit that reads programs from its own memory and executes the retrieved programs to selectively perform (1) an operation to supply a pixel drive voltage Vcom to the selection circuitry 35, (2) an operation to control the first transmitter 32 to transmit a finger detection signal FDS, (3) an operation to control the reception circuitry 34 to receive the finger detection signal FDS, (4) an operation to control the second transmitter 33 to transmit an uplink signal US to the electronic pen 14, or (5) an operation to control the reception circuitry 34 to receive a downlink signal DS from the electronic pen 14, for example. Further, the logic circuitry 31 is configured to generate control signals for the first transmitter 32, the second transmitter 33, the reception circuitry 34, and the selection circuitry 35 under control of the MCU 30.

In a case where the downlink signal DS is a “position signal” indicating the position of the electronic pen 14, the MCU 30 calculates position coordinates (x, y) of the electronic pen 14 on the touch surface 12s in accordance with the received signal strength of each of the plurality of sensor electrodes 20X and 20Y, and outputs the calculated coordinates to the host processor 24. On the other hand, in a case where the downlink signal DS is a “data signal” that includes transmission data, the MCU 30 acquires response data Res (specifically, unique identifier (ID), writing pressure, pen switch on/off information, etc.) included in the data signal, and outputs the acquired data to the host processor 24.

The first transmitter 32 is a circuit that generates the finger detection signal FDS under control of the MCU 30 and supplies the generated signal FDS to each of the sensor electrodes 20X via the selection circuitry 35. For example, the finger detection signal FDS is constituted by as many as K signals s₁ through s_{K} each made up of K pulses represented by “1” or “−1” each. The n-th pulse (n=1 through K) of each of the K signals s₁ through s_{K} constitutes a pulse group pₙ. The pulses making up one pulse group pₙ are input from the first transmitter 32 parallelly to the sensor electrodes 20X through the selection circuitry 35.

The second transmitter 33 has a function of generating the uplink signal US under control of the MCU 30 and the logic circuitry 31. Specifically, the second transmitter 33 includes a code sequence holding circuitry 40, a diffusion processor 41, and a transmission guard structure 42.

The code sequence holding circuitry 40 has a function of generating and holding a diffusion code of a predetermined chip length having a self-correlation characteristic in accordance with a control signal ctrl_t1 supplied from the logic circuitry 31. The diffusion code held by the code sequence holding circuitry 40 is supplied to the diffusion processor 41.

The diffusion processor 41 has a function of acquiring a transmission chip sequence having a predetermined chip length by modulating, in accordance with a command COM supplied via the MCU 30, the diffusion code held by the code sequence holding circuitry 40. The diffusion processor 41 supplies the acquired transmission chip sequence to the selection circuitry 35 via the transmission guard structure 42.

The transmission guard structure 42 has a function of inserting, in accordance with a control signal ctrl_t2 supplied from the logic circuitry 31, a guard period (i.e., a period in which neither transmission nor reception is performed) between two periods, one of the two periods being a period for transmitting the uplink signal US, the other period being a period for receiving the downlink signal DS, the guard period being required for switching between the transmission operation and the reception operation.

The reception circuitry 34 is a circuit that receives either the finger detection signal FDS transmitted from the first transmitter 32 or the downlink signal DS transmitted from the electronic pen 14, in accordance with a control signal ctrl_r from the logic circuitry 31. Specifically, the reception circuitry 34 includes an amplification circuit 45, a detection circuit 46, and an analog-digital (AD) converter 47.

The amplification circuit 45 amplifies and outputs the finger detection signal FDS or the downlink signal DS supplied from the selection circuitry 35. The detection circuit 46 is a circuit that generates a voltage corresponding to the level of the output signal from the amplification circuit 45. The AD converter 47 is a circuit that generates a digital signal by sampling, at predetermined time intervals, the voltage output from the detection circuit 46. The digital signal output from the AD converter 47 is supplied to the MCU 30.

The selection circuitry 35 is connected to the touch sensor 20 and performs switch operations in accordance with control signals from the logic circuitry 31. Specifically, the selection circuitry 35 includes two switches 48x and 48y and two electrode selection circuits 49x and 49y.

The switches 48x and 48y are each a switch element having a common terminal connected with one of terminals T1, T2, R, and D. The common terminal of the switch 48x is connected to the electrode selection circuit 49x, the terminal T1 is connected to an output terminal of the first transmitter 32, the terminal T2 is connected to an output terminal of the second transmitter 33, the terminal R is connected to an input terminal of the reception circuitry 34, and the terminal D is connected to an output terminal of the MCU 30. The common terminal of the switch 48y is connected to the electrode selection circuit 49y, the terminal T is connected to the output terminal of the second transmitter 33, and the terminal R is connected to the input terminal of the reception circuitry 34.

The electrode selection circuit 49x is a switch element for selectively connecting the plurality of sensor electrodes 20X to the common terminal of the switch 48x. That is, the electrode selection circuit 49x is configured to be able to connect at least some of the plurality of sensor electrodes 20X simultaneously to the common terminal of the switch 48x. The electrode selection circuit 49y is a switch element for selectively connecting the plurality of sensor electrodes 20Y to the common terminal of the switch 48y. That is, the electrode selection circuit 49y is configured to be able to connect at least some of the plurality of sensor electrodes 20Y simultaneously to the common terminal of the switch 48y.

The selection circuitry 35 is supplied with four control signals sTRx, sTRy, selX, and selY from the logic circuitry 31. Specifically, the control signal sTRy is supplied to the switch 48x, the control signal sTRx is supplied to the switch 48y, the control signal selX is supplied to the electrode selection circuit 49y, and the control signal selY is supplied to the electrode selection circuit 49x. The logic circuitry 31 performs switching control of the selection circuitry 35 by means of the four control signals sTRx, sTRy, selX, and selY, thereby selectively performing (1) transmission and reception of the finger detection signal FDS or (2) transmission of the uplink signal US and reception of the downlink signal DS.

The host processor 24 includes an arithmetic processing apparatus that includes a central processing unit (CPU), a graphics processing unit (GPU), and a micro-processing unit (MPU). The host processor 24 serves to execute an operating system of the electronic device 12 as well as various applications including drawing software by carrying out programs stored in a memory, which is not depicted. The drawing software includes two functions: a function of generating stroke data based on the coordinates supplied successively from the sensor controller 22 and rendering the generated stroke data before displaying the rendered data on a display unit and a function of adjusting the result of rendering on the basis of data such as a writing pressure value supplied from the sensor controller 22 (e.g., function of adjusting the line width in accordance with a writing pressure value).

### First Embodiment

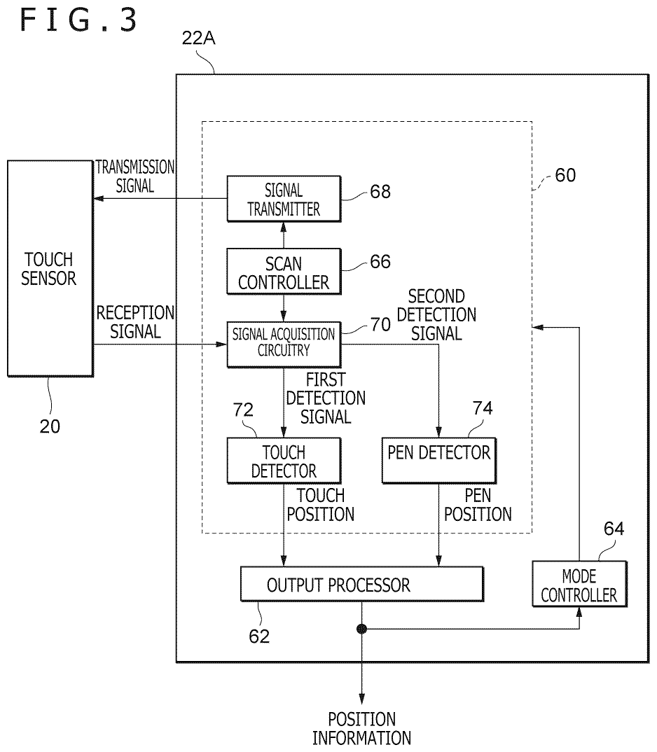

A sensor controller 22A in a first embodiment of the present disclosure is explained below with reference to FIGS. 3 through 8. The sensor controller 22A corresponds to one aspect of the sensor controller 22 in FIG. 2.

### Functional Block Diagram

FIG. 3 is a functional block diagram of the sensor controller 22A in the first embodiment. The sensor controller 22A includes a position detector 60, an output processor 62, and a mode controller 64.

The position detector 60 detects the position of the electronic pen 14 or the finger 16 through transmission and reception via the touch sensor 20 (more specifically, via the plurality of sensor electrodes 20X and 20Y). Specifically, the position detector 60 includes a scan controller 66, a signal transmitter 68, a signal acquisition circuitry 70, a touch detector 72, and a pen detector 74.

The scan controller 66 repeatedly performs a plurality of types of scan processes on a time-sharing basis via the touch sensor 20. The plurality of types of scan processes include (1) a “touch scan” for detecting the passive pointer not transmitting any signal (e.g., finger 16) and (2) a “pen scan” for detecting the electronic pen 14 transmitting the downlink signal DS. The touch scan and the pen scan may be carried out at a rate of 1 to 1, or n to m (n≠m).

The touch scan above is performed to detect changes in capacitance of the sensor electrodes 20X and 20Y. The touch scan may, for example, be one of two types: (1) a scan based on a “mutual capacitance system” that causes the sensor electrodes 20X to transmit the finger detection signal FDS and allows the sensor electrodes 20Y to receive the signal FDS in order to detect changes in mutual capacitance between the sensor electrodes 20X and 20Y or (2) a scan based on a “self-capacitance system” that detects changes in capacitance of each of the sensor electrodes 20X and 20Y.

The touch scan above has two operation modes: (1) a “normal mode” for detecting a touch in a normal state and (2) a “special mode” for detecting a touch in a special state. Examples of the special mode include a foreign matter adhesion mode and a glove-wearing mode. The “foreign matter adhesion mode” means an operation mode for detecting a touch at locations where there is foreign matter (e.g., water drops, a coin, etc.) adhering to the touch surface 12s of the electronic device 12. For example, a threshold for use in threshold processing is made relatively lower than in the normal mode in order to better detect a touch on conductive foreign matter. The “glove-wearing mode” means an operation mode for detecting a touch by the user wearing gloves. For example, a touch by a glove-wearing hand is detected more easily by activation of a high-pass filter that lets the detection signal in the high frequency band pass through.

The pen scan above has two scan operation modes: (1) a “global scan” for detecting the presence or absence and the position of the electronic pen 14 over an entire sensor area of the touch sensor 20 and (2) a “local scan” for detecting the presence or absence and the position of the electronic pen 14 in a limited region of the sensor area. For example, in a case where the global scan detects the electronic pen 14, the local scan is performed restrictively and with high positioning accuracy on the position at or close to which the electronic pen 14 has been most recently detected.

The pen scan has more operation modes: (1) an “active detection mode” for detecting the electronic pen 14 transmitting the downlink signal DS (i.e., active pen) and (2) a “passive detection mode” for detecting the electronic pen 14 not transmitting, or suspending transmission of, the downlink signal DS (i.e., passive pen). The pen scan has further operation modes: (3) an “in-phase mode” for continuously transmitting the in-phase uplink signal US and (4) a “phase inversion mode” for alternately transmitting a positive-phase signal and a negative-phase signal of the uplink signal US.

Under transmission control of the scan controller 66, the signal transmitter 68 causes the sensor electrodes 20X and 20Y to transmit desired signals for performing a touch scan or a pen scan. During execution of the touch scan, the signal transmitter 68 generates the signal for detecting the finger 16 (here, finger detection signal FDS) and transmits the generated finger detection signal FDS to transmission electrodes (here, at least one sensor electrode 20X). During execution of the pen scan, the signal transmitter 68 generates the signal for detecting the electronic pen 14 (here, uplink signal US) and transmits the generated uplink signal US to transmission electrodes (here, at least one sensor electrode 20X or 20Y)

It is to be noted that the signal transmitter 68 is configured to be able to transmit the uplink signal US in accordance with drive parameters corresponding to the operation mode selected by the mode controller 64. Exemplary drive parameters include (1) a length of a time slot assigned to the touch scan (also referred to as a “touch time length” hereunder), (2) a length of a time slot assigned to the pen scan (also referred to as a “pen time length” hereunder), and (3) a transmission rate of the uplink signal US. For example, when the finger 16 is detected by the touch scan, the signal transmitter 68 changes at least one of the drive parameters of the touch time length, the pen time length, and the transmission rate in order to make the frequency of transmitting the uplink signal US lower than when the finger 16 is not detected by the touch scan.

Other exemplary drive parameters include (1) a transmission voltage of the uplink signal US, (2) the number of the transmission electrodes, and (3) a length of an orthogonal code sequence formed by the uplink signal US. The “transmission electrodes” refer to the sensor electrodes 20X and 20Y used to transmit the uplink signal US. The “orthogonal code sequences” may include not only genuine orthogonal code sequences but also pseudo orthogonal code sequences.

Under reception control of the scan controller 66, the signal acquisition circuitry 70 receives or acquires desired signals for performing a touch scan or a pen scan from the sensor electrodes 20X and 20Y. During execution of the touch scan, the signal acquisition circuitry 70 receives, from reception electrodes (here, at least one sensor electrode 20Y), the finger detection signal FDS coming from the transmission electrodes, thereby acquiring the detection signal (or first detection signal) for detecting the presence or absence or the position of the finger 16. During execution of the pen scan, the signal acquisition circuitry 70 receives, from the reception electrodes (here, at least one sensor electrode 20X or 20Y), the downlink signal DS coming from the electronic pen 14, thereby acquiring the detection signal (or second detection signal) for detecting the presence or absence or the position of the electronic pen 14.

It is to be noted that the signal acquisition circuitry 70 is configured to be able to receive the downlink signal DS in accordance with the drive parameters corresponding to the operation mode selected by the mode controller 64. Exemplary drive parameters include (1) the length of the time slot assigned to the touch scan (that is, the touch time length), (2) the length of the time slot assigned to the pen scan (that is, the pen time length), and (3) a reception rate of the downlink signal DS. For example, when the finger 16 is detected by the touch scan, the signal acquisition circuitry 70 changes at least one of the drive parameters of the touch time length, the pen time length, and the reception rate in order to make the frequency of receiving the downlink signal DS lower than when the finger 16 is not detected by the touch scan.

The touch detector 72 calculates the presence or absence or the position (generically referred to as a “touch position” hereunder) of the passive pointer (here, finger 16) by performing diverse signal processing on the first detection signal acquired by the signal acquisition circuitry 70. The signal processing includes (1) “threshold processing” for detecting the presence or absence of the finger 16 on the basis of the magnitude relation between a threshold and a signal value at each position indicated by a signal distribution, (2) “identification processing” for identifying the type of touch (e.g., by finger 16, palm, or some other object) on the basis of the size or shape of the region detected by the threshold processing, and (3) “position calculation processing” for calculating the touch position by performing interpolation or approximation calculation on the signal distribution.

The pen detector 74 calculates the presence or absence or the position (generically referred to as a “pen position” hereunder) of the active pen (here, electronic pen 14) by performing diverse signal processing on the second detection signal acquired by the signal acquisition circuitry 70. The signal processing includes (1) “threshold processing” for detecting the presence or absence of the electronic pen 14 on the basis of the magnitude relation between a threshold and a signal value at each position indicated by a signal distribution and (2) “position calculation processing” for calculating the pen position by performing interpolation or approximation calculation on the signal distribution.

After generating position information including the pen position or the touch position calculated by the position detector 60, the output processor 62 outputs data including the calculated position information to the host processor 24 (FIG. 2). The output processor 62 may output the data at predetermined intervals (e.g., 120 Hz). In addition to the position information regarding the electronic pen 14, the data may include (1) information provided by the electronic pen 14 (e.g., pen ID, writing pressure, pen switch on/off information, etc.), (2) information calculated from the position information (e.g., tilt angle, bearing, velocity, acceleration, etc.), and (3) identification information identifying the currently executed operation mode.

The mode controller 64 switches and executes a plurality of types of operation modes in combination with the touch scan or the pen scan. Exemplary operation modes include (1) a “simultaneous pen and touch (SPT) mode” for detecting the position of the electronic pen 14 and the position of the finger 16 on a time-sharing basis and (2) an “exclusive mode” for detecting only the position of the electronic pen 14 by temporarily suspending the detection of the finger 16. In the SPT mode, for example, it is possible to select any one of various combinations of the “type” of the time slot making up a repetitive unit of operation, the “ratio” of the numbers of time slots, and the “time length” of the time slot.

The mode controller 64 may selectively execute a first mode when the finger 16 is detected, and selectively execute a second mode when the finger 16 is not detected. Here, the “first mode” is an operation mode in which the time slot of the touch scan is assigned to a first touch time length and the time slot of the pen scan is assigned to a first pen time length. The “second mode” is an operation mode in which the time slot of the touch scan is assigned to a second touch time length and the time slot of the pen scan is assigned to a second pen time length.

The execution cycle of the second mode (referred to as a second execution cycle hereunder) may or may not be the same as the execution cycle of the first mode (referred to as a first execution cycle hereunder). In a case where the execution cycle is the same for both the first and second modes, the second touch time length is given by subtracting a predetermined value from the first touch time length, and the second pen time length is given by adding the predetermined value to the first pen time length. The predetermined value is a positive value smaller than the value of the first touch length.

In the second mode, whereas the pen time length is extended, the transmission frequency or the transmission voltage of the uplink signal US is relatively lowered. Examples of the transmission frequency include (1) the transmission rate or (2) the number of times of transmission in the time slot. The “transmission rate” is defined as the number of times of transmission of the uplink signal US per unit time. The “number of times of transmission in the time slot” is defined as the product of the pen time length and the transmission rate.

Here, the transmission rate in the first mode is defined as a “first transmission rate,” the number of times of transmission in the time slot in the first mode is defined as a “first transmission count,” the transmission rate in the second mode is defined as a “second transmission rate,” and the number of times of transmission in the time slot in the second mode is defined as a “second transmission count.” In this case, there may be two kinds of settings: (1) the second transmission rate is made lower than the first transmission rate or (2) the second transmission count is made smaller than the first transmission count. In particular, the ratio of the second transmission count to the first transmission count should preferably be at least 0.3 but less than 1.

### Overall Operation

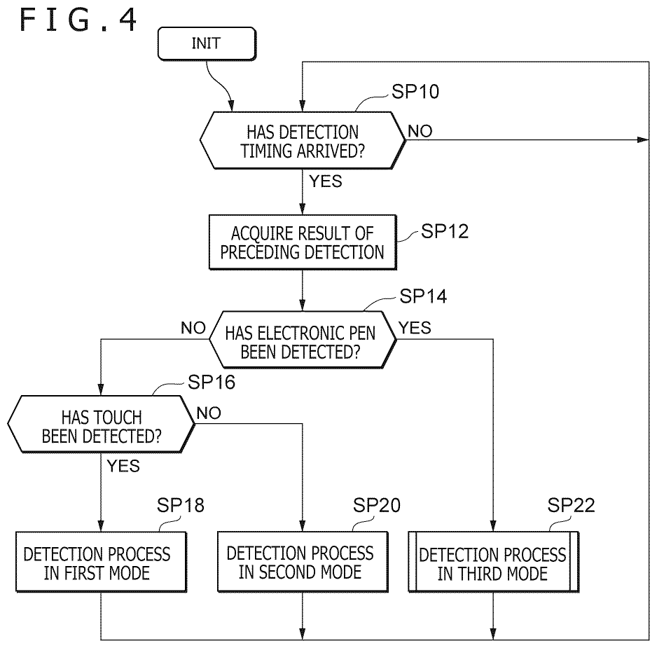

The sensor controller 22A in the first embodiment is configured as described above. The detection operation performed by the sensor controller 22A is explained next with reference to the flowchart of FIG. 4.

In step SP10, the mode controller 64 of the sensor controller 22A determines whether or not a detection timing has arrived. In a case where a detection timing has yet to arrive (NO in step SP10), the sensor controller 22A remains in step SP10 until a detection timing arrives. On the other hand, in a case where a detection timing has arrived (YES in step SP10), the sensor controller 22A goes to step SP12.

In step SP12, the mode controller 64 acquires the result of detection obtained by the preceding touch scan and pen scan (i.e., result of the preceding detection).

In step SP14, the mode controller 64 determines whether or not the electronic pen 14 has been detected by the preceding pen scan, by referencing the result of detection acquired in step SP12. In a case where the electronic pen 14 has not been detected (NO in step SP14), the mode controller 64 goes to step SP16.

In step SP16, the mode controller 64 determines whether or not a touch by the finger 16 has been detected by the preceding touch scan, by referencing the result of detection acquired in step SP12. In a case where the touch has been detected (YES in step SP16), the mode controller 64 supplies the position detector 60 (more specifically, scan controller 66) with a mode flag indicative of the first mode, and goes to step SP18.

In step SP18, the position detector 60 of the sensor controller 22A performs detection processing in the first mode selected in step SP16. Thereafter, the sensor controller 22A returns to step SP10 and repeatedly executes steps SP10, SP12, SP14, SP16, and SP18 when the first mode is continuously selected.

Described with reference to step SP16 again, in a case where a touch has not been detected by the preceding touch scan (NO in step SP16), the mode controller 64 supplies the position detector 60 (more specifically, scan controller 66) with a mode flag indicative of the second mode, and goes to step SP20.

In step SP20, the position detector 60 performs detection processing in the second mode selected in step SP16. Thereafter, the sensor controller 22A returns to step SP10 and repeatedly executes steps SP10, SP12, SP14, SP16, and SP20 when the second mode is continuously selected.

Described with reference to step SP14 again, in a case where the electronic pen 14 has been detected by the preceding pen scan (YES in step SP14), the mode controller 64 supplies the position detector 60 (more specifically, scan controller 66) with a mode flag indicative of a third mode, and goes to step SP22.

In step SP22, the position detector 60 performs detection processing in the third mode selected in step SP14. Thereafter, the sensor controller 22A returns to step SP10 and repeatedly executes steps SP10, SP12, SP14, and SP22 when the third mode is continuously selected.

In this manner, the sensor controller 22A performs in real time the operation of detecting the pointed position (here, touch position and pen position) by repeatedly executing steps SP10 through SP22.

### Explanation of First and Second Modes

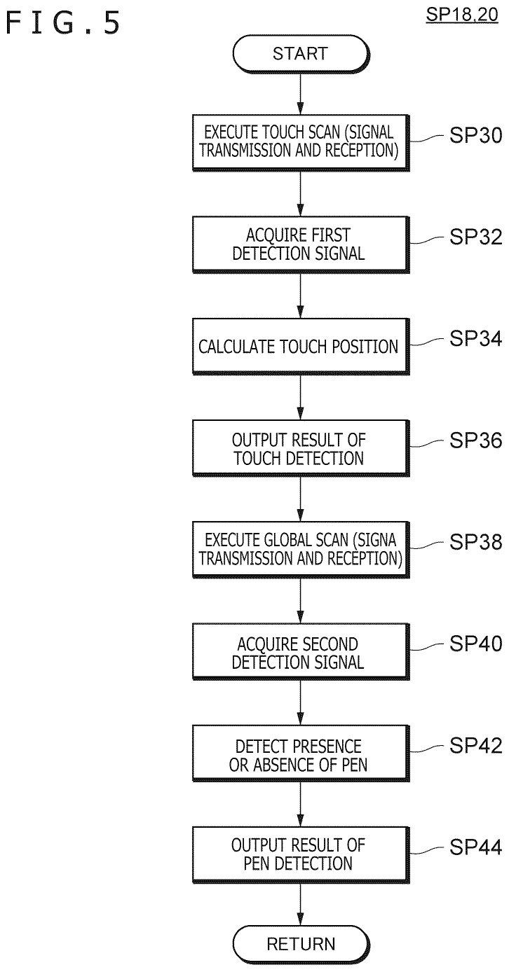

The detection processing in the first mode (step SP18) or in the second mode (step SP20) in FIG. 4 is explained below in detail with reference to the flowchart of FIG. 5.

In step SP30, the scan controller 66 performs transmission control of the signal transmitter 68 and reception control of the signal acquisition circuitry 70, thereby executing the touch scan via the plurality of sensor electrodes 20X and 20Y.

In step SP32, the signal acquisition circuitry 70 acquires the first detection signal corresponding to the touch scan performed in step SP30.

In step SP34, the touch detector 72 calculates the touch position from the first detection signal acquired in step SP32.

In step SP36, the output processor 62 generates position information including the touch position calculated in step SP34, and supplies data including the generated position information to the host processor 24. Upon completion of the touch scan, the position detector 60 goes to step SP38.

In step SP38, the scan controller 66 performs transmission control of the signal transmitter 68 and reception control of the signal acquisition circuitry 70, thereby executing the global scan via the plurality of sensor electrodes 20X and 20Y. Prior to the transmission and reception control, the drive parameters corresponding to the first mode or the second mode are set.

In step SP40, the signal acquisition circuitry 70 acquires the second detection signal corresponding to the global scan performed in step SP38.

In step SP42, the pen detector 74 calculates the pen position from the second detection signal acquired in step SP40.

In step SP44, the output processor 62 generates position information including the pen position calculated in step SP42, and supplies data including the generated position information to the host processor 24. In this manner, the sensor controller 22A terminates the detection processing in the first mode or the second mode.

### Explanation of Operation Modes

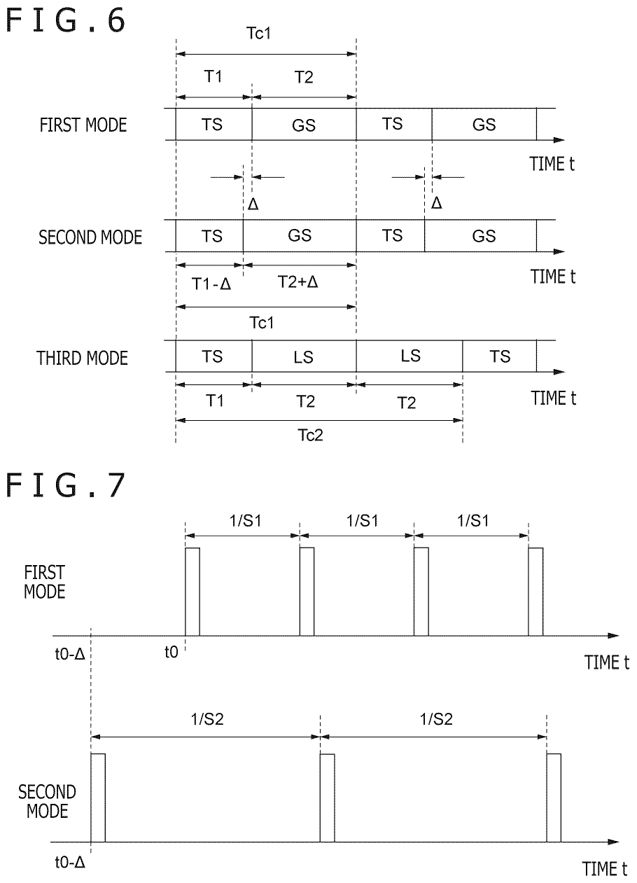

FIG. 6 is a view indicating exemplary operation modes for the sensor controller 22A. The sensor controller 22A (more specifically, mode controller 64) is switched to operate in one of the first, second, and third modes.

The first mode corresponds to an operation mode in which one touch scan (TS) and one global scan (GS) are carried out on a time-sharing basis. The time slot for the touch scan is assigned a time length T1 (in units of milliseconds). The time slot for the global scan is assigned a time length T2 (in unis of milliseconds). That is, (1) one touch scan whose time length is T1 and (2) one global scan whose time length is T2 constitute one unit of operation (cycle: Tc1=T1+T2).

The second mode, as with the first mode, corresponds to the operation mode in which one touch scan (TS) and one global scan (GS) are carried out on a time-sharing basis. It is to be noted, however, that, in the second mode, a time length different from that in the first mode is assigned. The time slot for the touch scan is assigned a time length T1−Δ (in units of milliseconds). The time slot for the global scan is assigned a time length T2+Δ (in units of milliseconds). That is, (1) one touch scan whose time length is (T1−Δ) and (2) one global scan whose time length is (T2+Δ) constitute one unit of operation (cycle: Tc1=T1+T2).

The third mode corresponds to an operation mode in which one touch scan (TS) and two local scans (LS) are carried out on a time-sharing basis. The time slot for the touch scan is assigned a time length T1 (in units of milliseconds). The time slot for the local scan is assigned a time length T2 (in units of milliseconds). That is, (1) one touch scan whose time length is T1, (2) one local scan whose time length is T2, and (3) one local scan whose time length is T2 constitute one unit of operation (cycle: Tc2=T1+2·T2).

FIG. 7 is a time chart regarding transmission of the uplink signal US. Rectangular pulses indicate individual timings at which one sensor electrode 20X transmits the uplink signal US. In the first mode, the uplink signal US is transmitted at a transmission rate of S1 [Hz] starting at time t=t0, i.e., transmitted intermittently in a cycle of 1/S1 [s]. In the second mode, on the other hand, the uplink signal US is transmitted at a transmission rate of S2 [Hz] starting at time t=t0−Δ, i.e., transmitted intermittently in a cycle of 1/S2 [s]. As a result, when one global scan is performed, the number of times of transmission of the uplink signal US in the second mode is made smaller than in the first mode. This makes it possible, in the second mode, to assign a longer time to the detection of the electronic pen 14 while minimizing an increase in power consumption attributable to the transmission of the uplink signal US.

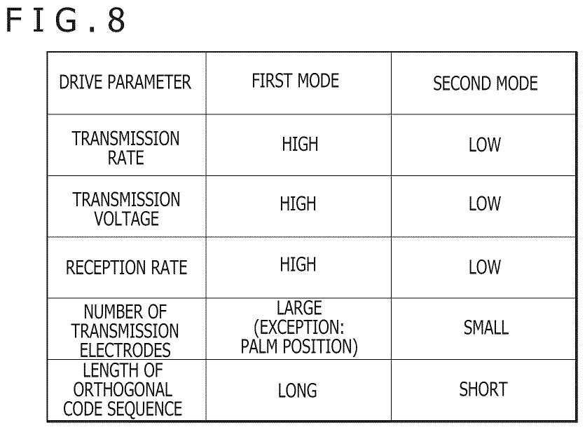

FIG. 8 is a tabular view indicating exemplary settings regarding transmission of the uplink signal US or reception of the downlink signal DS. The transmission rate is set to be relatively high in the first mode but relatively low in the second mode. The transmission voltage is set to be relatively high in the first mode but relatively low in the second mode. The reception rate is set to be relatively high in the first mode but relatively low in the second mode. The number of transmission electrodes is set to be relatively large in the first mode but relatively small in the second mode. The length of the orthogonal code sequence is set to be relatively long in the first mode but relatively short in the second mode. These settings make it possible, in the second mode, to assign a longer time to the detection of the electronic pen 14 while minimizing an increase in power consumption attributable to the transmission of the uplink signal US or the reception of the downlink signal DS.

It is to be noted that, in a case where a palm is detected by the touch scan, the number of transmission electrodes may be reduced at or near the position of the palm even during execution of the first mode. This makes it possible to prevent signals induced by the electronic pen 14 from becoming temporarily undetectable due to fluctuation of reference potential attributable to signals induced via the palm in the human body.

### Summary of First Embodiment

As described above, the electronic device 12 in the first embodiment includes the capacitive touch sensor 20 having the plurality of sensor electrodes 20X and 20Y arranged planarly and the sensor controller 22 or 22A connected to the touch sensor 20. The sensor controller 22A includes the scan controller 66 and the signal transmitter 68. The scan controller 66 executes a plurality of types of operation modes where the pen scan detecting the active pen (here, electronic pen 14) transmitting the downlink signal DS and the touch scan detecting the passive pointer (here, finger 16) not transmitting the downlink signal DS are repeatedly executed on the plurality of sensor electrodes 20X and 20Y on a time-sharing basis. The signal transmitter 68 transmits the uplink signal US requesting the downlink signal DS via the sensor electrodes 20X and 20Y during execution of the pen scan. When the finger 16 is not detected by the touch scan, the signal transmitter 68 makes the transmission frequency of the uplink signal US lower than when the finger 16 is detected.

Further, the position detection method of the first embodiment includes an execution step (SP18 and SP20) causing the sensor controller 22A to repeatedly execute the pen scan and the touch scan on the plurality of sensor electrodes 20X and 20Y on a time-sharing basis. It also includes a transmission step (SP30) causing the sensor controller 22A to transmit the uplink signal US via the sensor electrodes 20X and 20Y during execution of the pen scan. In the transmission step, when the finger 16 is not detected by the touch scan, the transmission frequency of the uplink signal US is caused to be lower than when the finger 16 is detected by the touch scan.

As described above, when the finger 16 is not detected by the touch scan, the transmission frequency of the uplink signal US is made relatively low. This makes it possible to spontaneously reduce the power consumption in detecting the pointed position in the detected state of the touch sensor 20, especially when the finger 16 is not detected.

Moreover, in the case where the plurality of types of operation modes include the first mode, in which the time slot for the touch scan is assigned to the first touch time length (T1) and the time slot for the pen scan is assigned to the first pen time length (T2), and the second mode, in which the time slot for the touch scan is assigned to the second touch time length (T1−Δ) and the time slot for the pen scan is assigned to the second pen time length (T2+Δ), the scan controller 66 may selectively execute the first mode when the finger 16 is detected and selectively execute the second mode when the finger 16 is not detected. This makes it possible, when the finger 16 is not detected, to assign a longer time to the detection of the electronic pen 14 through execution of the second mode.

In addition, the second touch time length may be a value given by subtracting the predetermined value (Δ) from the first touch time length (T1), and the second pen time length may be a value given by adding the predetermined value (Δ) to the first pen time length (T2). This makes it possible to keep constant the execution cycle of units of the scan operation regardless of the mode transitions that may occur between the first mode and the second mode.

Further, when the number of transmissions of the uplink signal US per unit time in the first mode is defined as the first transmission rate (S1) and the number of transmissions of the uplink signal US per unit time in the second mode is defined as the second transmission rate (S2), the product of the second pen time length (T2−Δ) and the second transmission rate (S2) may be smaller than the product of the first pen time length (T2) and the first transmission rate (S1). This makes it possible, in the second mode, to assign a longer time to the detection of the electronic pen 14 while minimizing an increase in power consumption attributable to the transmission of the uplink signal US.

Moreover, the pen scan may be a global scan for detecting the electronic pen 14 over the entire sensor area provided by the touch sensor 20. In particular, since the range of search in the case of the global scan is widened, the probability of detecting the electronic pen 14 is that much heightened.

In addition, when the finger 16 is not detected by the touch scan, the signal transmitter 68 may (1) make the transmission voltage for the uplink signal US lower, (2) make the number of sensor electrodes 20X and 20Y used to transmit the uplink signal US smaller, or (3) make the orthogonal code sequence used to encode the uplink signal US shorter, than when the finger 16 is detected by the touch scan. This makes it possible, when the finger 16 is not detected, to spontaneously reduce the power consumption in detecting the pointed position.

Also, the sensor controller 22A further includes the signal acquisition circuitry 70 that receives and acquires the downlink signal DS from the plurality of sensor electrodes 20X and 20Y during execution of the pen scan. When the finger 16 is not detected by the touch scan, the signal acquisition circuitry 70 may make the reception frequency of the downlink signal DS lower than when the finger 16 is detected by the touch scan. This makes it possible, when the finger 16 is not detected, to spontaneously reduce the power consumption in detecting the pointed position.

### First Modification

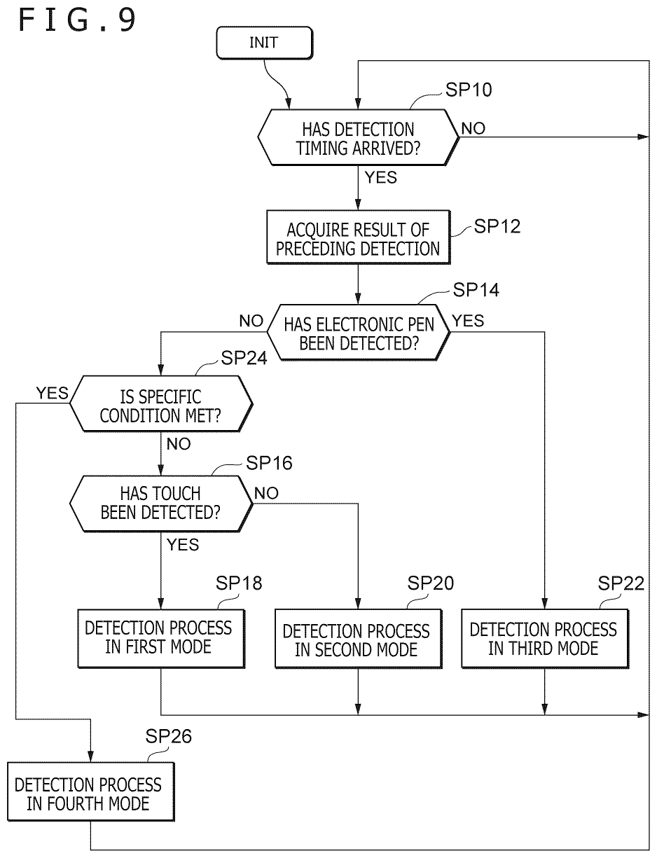

FIG. 9 is a flowchart regarding a first modification of the first embodiment. The flowchart of FIG. 9 is different from that of FIG. 4 in that step SP24 and SP26 are added. The operations in steps SP10 through SP22 are similar to those in the case of the flowchart in FIG. 4 and thus will not be discussed further.

In a case where the electronic pen 14 has not been detected in step SP14 in FIG. 9 (NO in step SP14), the mode controller 64 of the sensor controller 22A goes to step SP24 before transitioning to step SP16.

In step SP24, the mode controller 64 determines whether or not a specific condition is met. Examples of the “specific condition” include (1) a condition under which a disconnection of at least one sensor electrode 20X or 20Y is detected, (2) a condition under which the passive detection mode is being executed by the scan controller 66, and (3) a condition under which the special mode (e.g., the above-mentioned foreign matter adhesion mode or glove-wearing mode) is being executed by the scan controller 66.

In a case where the specific condition is not met (NO in step SP24), the mode controller 64 goes to step SP16 and performs the touch detection processing (step SP16). On the other hand, in a case where the specific condition is met (YES in step SP24), the mode controller 64 supplies a mode flag indicative of a fourth mode to the position detector 60 (more specifically, to the scan controller 66), and goes to step SP26.

In step SP26, the position detector 60 of the sensor controller 22A performs detection processing in the fourth mode selected in step SP24. When transmitting the uplink signal US, the signal transmitter 68 (1) makes the transmission frequency higher, (2) makes the transmission voltage higher, (3) makes the number of transmission electrodes larger, or (4) makes the orthogonal code sequence longer, than in any one of the first through the third modes.

Thereafter, the sensor controller 22A returns to step SP10 and performs steps SP10, SP12, SP14, SP16, SP24, and SP26 when the fourth mode is continuously selected.

In this manner, in the case where the specific condition is met, the signal transmitter 68 may make the transmission frequency of the uplink signal US higher, the transmission voltage of the uplink signal US higher, the number of transmission electrodes larger, or the orthogonal code sequence longer, than when the specific condition is not met. This increases the possibility that the electronic pen 14 can be detected by the pen scan even in a situation where it is difficult to detect the electronic pen 14.

### Second Modification

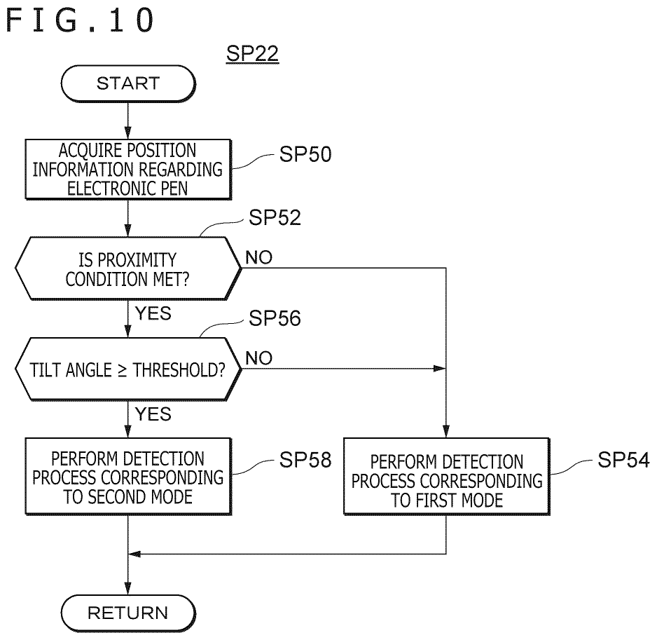

FIG. 10 is a flowchart regarding a second modification of the first embodiment. FIG. 10 corresponds to a detailed flowchart with regard to step SP22 in FIG. 4 (detection processing in the third mode).

In step SP50 in FIG. 10, the position detector 60 acquires the position information regarding the electronic pen 14 detected by the most recent pen scan.

In step SP52, the position detector 60 determines whether or not a proximity condition indicating the state of the electronic pen 14 being close to or in contact with the touch sensor 20 (also referred to as the “proximity condition” hereunder) is met, in reference to the position information acquired in step SP50. Examples of the proximity condition include (1) a condition under which the reception intensity of the downlink signal DS is higher than a threshold or (2) a condition under which a writing pressure value detected by a writing pressure sensor (not depicted) is non-zero.

In a case where the proximity condition is not met (NO in step SP52), the position detector 60 goes to step SP54. In a case where the proximity condition is met (YES in step SP52), the position detector 60 goes to step SP56.

In step SP54, the position detector 60 performs the detection processing identical or corresponding to that in the first mode, before terminating the operations in the flowchart of FIG. 10. For example, upon transmitting the uplink signal US, the signal transmitter 68 makes the transmission voltage relatively high or makes the orthogonal code sequence relatively long.

In step SP56, the position detector 60 verifies the magnitude relation between the tilt angle of the electronic pen 14 and a threshold in reference to the position information acquired in step SP50. In a case where the tilt angle is less than the threshold (NO in step SP56), the position detector 60 performs the detection processing identical or corresponding to that in the first mode (step SP54), before terminating the operations in the flowchart of FIG. 10. On the other hand, in a case where the tilt angle is equal to or larger than the threshold (YES in step SP56), the position detector 60 goes to step SP58.

In step SP58, the position detector 60 performs the detection processing identical or corresponding to that in the second mode, before terminating the operations in the flowchart of FIG. 10. For example, upon transmitting the uplink signal US, the signal transmitter 68 makes the transmission voltage relatively low or makes the orthogonal code sequence relatively short.

In this manner, in the case where the proximity condition indicating the state of the electronic pen 14 being close to or in contact with the touch sensor 20 is met, the signal transmitter 68 may change the transmission voltage of the uplink signal US or change the length of the orthogonal code sequence in accordance with the tilt angle of the electronic pen 14.

For example, the larger the tilt angle of the electronic pen 14, the lower the transmission voltage of the uplink signal US may be made or the shorter the orthogonal code sequence may be rendered by the signal transmitter 68. Conversely, the smaller the tilt angle of the electronic pen 14, the higher the transmission voltage of the uplink signal US may be made or the longer the orthogonal code sequence may be rendered by the signal transmitter 68. In a situation where the use of the electronic pen 14 is highly probable and the electronic pen 14 is highly likely to be detected, it is possible to spontaneously reduce the power consumption for the detection of the electronic pen 14.

Alternatively, in a case where the above-described proximity condition is not met, the signal transmitter 68 may raise the transmission voltage of the uplink signal US or prolong the orthogonal code sequence. This makes it possible to spontaneously increase the detection sensitivity of the electronic pen 14 in a situation where the electronic pen 14 is positioned away from the touch sensor 20 and it is difficult to detect the electronic pen 14.

### Second Embodiment

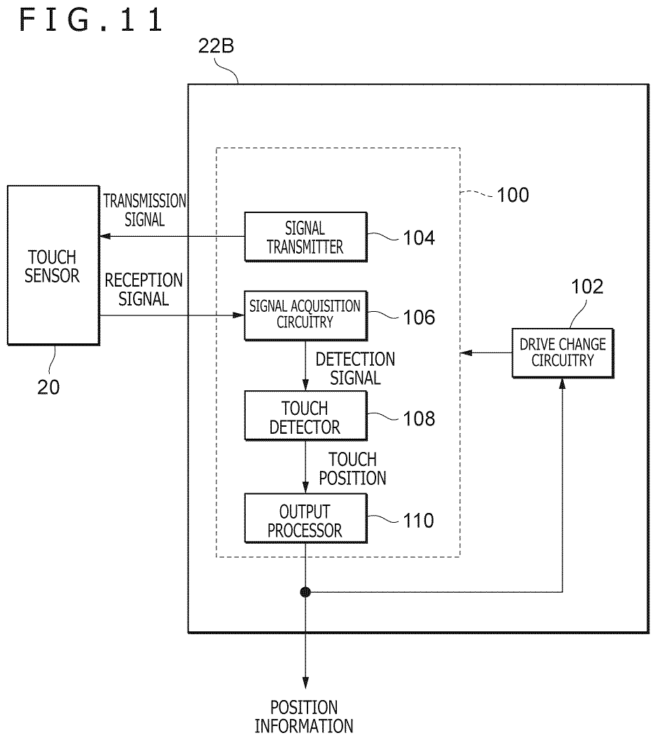

A sensor controller 22B in a second embodiment of the present disclosure is explained below with reference to FIGS. 11 through 19. The sensor controller 22B corresponds to another aspect of the sensor controller 22 in FIG. 2.

Sensor controllers that parallelly drive Tx electrodes tend to consume more power than those serially driving the electrodes. In particular, in a case where an on-cell touch panel of a large load capacity (e.g., 1000 pF) is parallelly driven, an inordinately large power consumption can lead to a problem of heat generation inside the touch panel. It is thus desired to reduce the power consumption in the operation of driving the touch sensor 20.

### Functional Block Diagram

FIG. 11 is a functional block diagram of the sensor controller 22B in the second embodiment of this disclosure. The sensor controller 22B includes a detection processor 100 and a drive change circuitry 102. It is to be noted that, whereas the constituent elements related to the function of detecting the electronic pen 14 are omitted from FIG. 11, the sensor controller 22B may include the pen detection function as in the case of the first embodiment (FIG. 3).

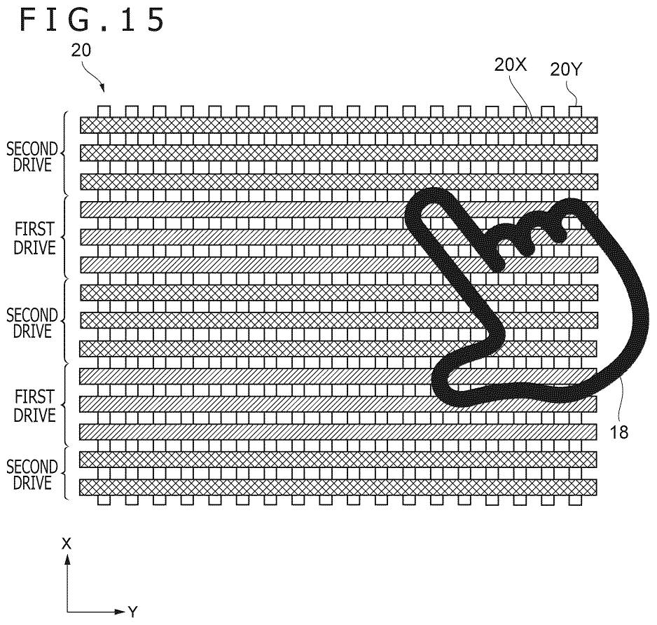

The detection processor 100 repeatedly executes a touch scan for detecting a passive pointer not transmitting any signal (e.g., hand 18 in FIG. 15) via a plurality of sensor electrodes 20X and 20Y, where the touch scan includes a specific drive operation. Specifically, the detection processor 100 includes a signal transmitter 104, a signal acquisition circuitry 106, a touch detector 108, and an output processor 110.

During execution of the touch scan, the signal transmitter 104 generates a signal for detecting the hand 18 (e.g., finger detection signal FDS), and outputs the generated finger detection signal FDS to transmission electrodes (here, at least one sensor electrode 20X) for transmission. The signal transmitter 104 is configured to be able to generate and transmit the finger detection signal FDS in accordance with drive parameters supplied from the drive change circuitry 102. Exemplary drive parameters include (1) electrode information for identifying the positions, spacing, or number of the sensor electrodes 20X used as the transmission electrodes, (2) code information for identifying a plurality of orthogonal code sequences formed by the finger detection signal FDS, and (3) a transmission voltage of the finger detection signal FDS.

During execution of the touch scan, the signal acquisition circuitry 106 receives the finger detection signal FDS from the transmission electrodes (here, at least one sensor electrode 20X) via reception electrodes (here, at least one sensor electrode 20Y) so as to acquire a detection signal for detecting the hand 18. The signal acquisition circuitry 106 is configured to be able to receive or acquire the finger detection signal FDS in accordance with drive parameters supplied from the drive change circuitry 102. Exemplary drive parameters include (1) electrode information for identifying the positions, spacing, or number of the sensor electrodes 20Y used as the reception electrodes and (2) the number of samples for statistically processing the detection signal.

The touch detector 108 calculates the presence or absence or the position (i.e., touch position) of the hand 18 by performing diverse signal processing on the detection signal acquired by the signal acquisition circuitry 106. As in the case of the first embodiment (touch detector 72 in FIG. 3), the signal processing includes the threshold processing, identification processing, and position calculation processing.

After generating position information including the touch position calculated by the touch detector 108, the output processor 110 outputs data including the calculated position information to the host processor 24 (FIG. 2). The output processor 110 is configured to be able to generate data on its own and output the generated data in accordance with drive parameters supplied from the drive change circuitry 102. An exemplary drive parameter is the number of outputs per unit time (i.e., output rate).

The drive change circuitry 102 changes the drive parameters related to a specific drive operation included in the touch scan. Specifically, when the passive pointer (e.g., hand 18) is not detected by the touch scan, the drive change circuitry 102 changes the drive parameters in such a manner as to make the execution frequency of the specific drive operation lower or make the execution amount thereof smaller than when the hand 18 is detected.

The drive change circuitry 102 may classify the plurality of sensor electrodes 20X and 20Y constituting the touch sensor 20 into a plurality of electrode groups and may set the drive parameters for each of the electrode groups. Exemplary electrode groups may include a “first electrode group” as an aggregate of sensor electrodes 20X and 20Y corresponding to the detected positions at or close to which the hand 18 is detected and a “second electrode group” as an aggregate of sensor electrodes 20X and 20Y corresponding to the positions at which the hand 18 is not detected. For example, the drive change circuitry 102 may classify into the first electrode group those sensor electrodes 20X and 20Y located at the positions corresponding to values detected most recently by the touch scan, in correlation to the amount of change in capacitance, those detected values exceeding a threshold and classify into the second electrode group those sensor electrodes 20X and 20Y located at the positions corresponding to the detected values not exceeding the threshold.

In this case, the drive change circuitry 102 may set, for the first electrode group, a first drive parameter for either making the execution frequency of a specific drive operation relatively high or making the execution amount of the specific drive operation relatively large, and may set, for the second electrode group, a second drive parameter for either making the execution frequency of the specific drive operation relatively low or making the execution amount of the specific drive operation relatively small.

Examples of the “specific drive operation” include (1) an output process of outputting data including the detected positions of the hand 18 to the outside, (2) a statistical process of performing statistical calculations on a plurality of sampled values obtained by the touch scan, (3) a transmission process of transmitting the finger detection signal FDS to the sensor electrodes 20X, and (4) a reception process of receiving the finger detection signal FDS from the sensor electrodes 20Y.

As a first example, the drive parameters may include the number of outputs per unit time in the output process. In this case, the drive change circuitry 102 sets a relatively large number of outputs as the first drive parameter for the first electrode group, and sets a relatively small number of outputs as the second drive parameter for the second electrode group.

As a second example, the drive parameters may include the number of samples in the statistical process. In this case, the drive change circuitry 102 sets a relatively large number of samples as the first drive parameter for the first electrode group, and sets a relatively small number of samples as the second drive parameter for the second electrode group.

As a third example, the drive parameters may include a plurality of orthogonal code sequences formed by the finger detection signal FDS (here, not only genuine orthogonal code sequences but also pseudo orthogonal code sequences apply). In this case, the drive change circuitry 102 sets a different orthogonal code sequence as the first drive parameter for each of the sensor electrodes 20X belonging to the first electrode group, and sets a common orthogonal code sequence as the second drive parameter for at least two sensor electrodes 20X belonging to the second electrode group.

As a fourth example, the drive parameters may include the number of or the usage rate of the sensor electrodes 20X used in the transmission process. In this case, the drive change circuitry 102 sets either a relatively large number of or a relatively high usage rate of the sensor electrodes 20X as the first drive parameter for the first electrode group, and sets either a relatively small number of or a relatively low usage rate of the sensor electrodes 20X as the second drive parameter for the second electrode group.

As a fifth example, the drive parameters may include the number of or the usage rate of the sensor electrodes 20Y used in the reception process. In this case, the drive change circuitry 102 sets either a relatively large number of or a relatively high usage rate of the sensor electrodes 20Y as the first drive parameter for the first electrode group, and sets either a relatively small number of or a relatively low usage rate of the sensor electrodes 20Y as the second drive parameter for the second electrode group.

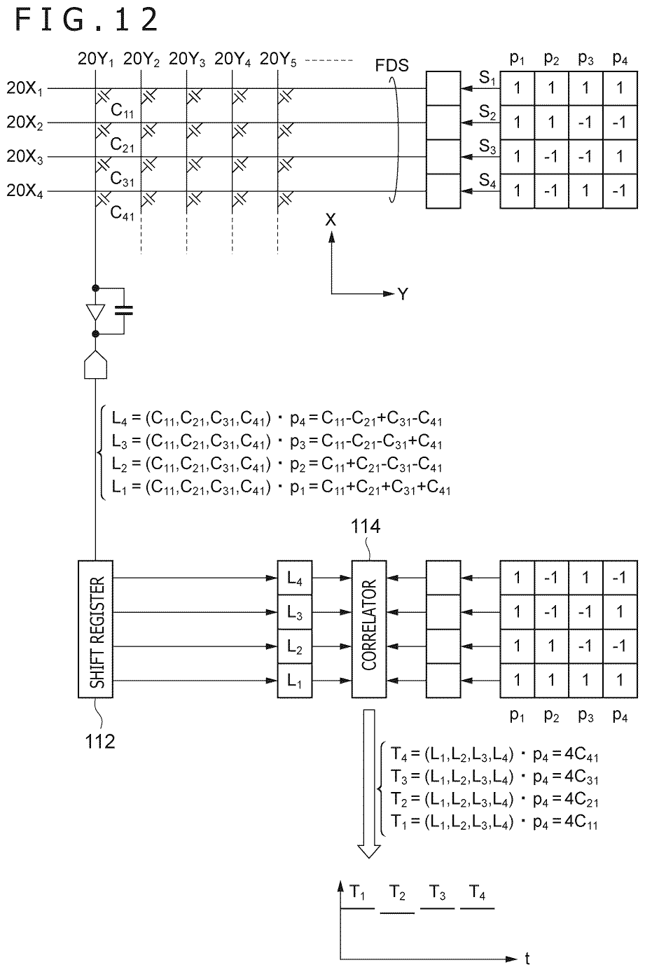

FIG. 12 is a view schematically depicting a method of detecting a touch by use of orthogonal code sequences. In a case where there are four sensor electrodes 20X, signals S₁ through S₄ are each made up of four pulses each representing “1” or “−1.” Specifically, as depicted in FIG. 12, a signal S₁ is constituted by “1, 1, 1, 1,” a signal S₂ by “1, 1, −1, −1,” a signal S₃ by “1, −1, −1, 1,” and a signal S₄ by “1, −1, 1, −1.” Capacitances between a sensor electrode 20Y₁ on one hand and four sensor electrodes 20X₁ through 20X₄ on the other hand are given as C₁₁ through C₄₁, respectively.

A level {Lᵢ} held in a shift register 112 in correspondence to a pulse group {pᵢ} (i=1 to 4) is the inner product between a vector of the capacitances and a vector indicative of the pulse group {pᵢ}. A correlator 114 successively calculates a correlation value {Tᵢ} between each of the four pulse groups {pᵢ} on one hand and the level {Lᵢ} accumulated in the shift register 112 on the other hand. In the example of FIG. 12, the result of the calculation is that T₁=4·C₁₁, T₂=4·C₂₁, T₃=4·C₃₁, and T₄=4·C₄₁. By referencing the correlation value {Tᵢ} calculated for each sensor electrode 20Y, it is possible to detect the touch position.

### Overall Operation

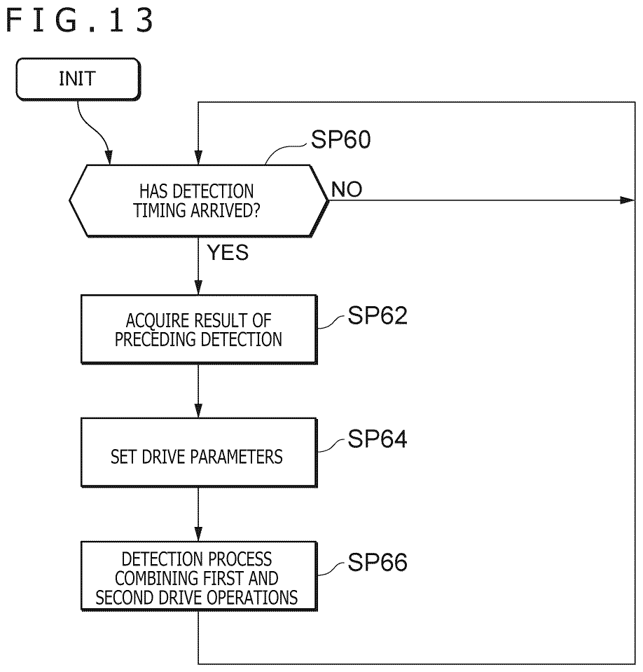

The sensor controller 22B in the second embodiment is configured as described above. The detection operation performed by the sensor controller 22B is explained next with reference to the flowchart of FIG. 13.

In step SP60 in FIG. 13, the sensor controller 22B determines whether or not a detection timing has arrived. In a case where a detection timing has yet to arrive (NO in step SP60), the sensor controller 22B remains in step SP60 until a detection timing arrives. On the other hand, in a case where a detection timing has arrived (YES in step SP60), the sensor controller 22B goes to step SP62.

In step SP62, the drive change circuitry 102 acquires the result of detection obtained by the preceding touch scan (i.e., result of the preceding detection).

In step SP64, the drive change circuitry 102 sets drive parameters based on the result of detection acquired in step SP62, and supplies the drive parameters to the detection processor 100.

In step SP66, the detection processor 100 performs the detection process, combining a first drive operation and a second drive operation in accordance with the drive parameters set in step SP64. Thereafter, the sensor controller 22B returns to step SP60 and repeatedly executes steps SP60 through SP66, thereby performing the operation of detecting in real time the pointed position (here, touch position).

### Specific Examples of Drive Operations

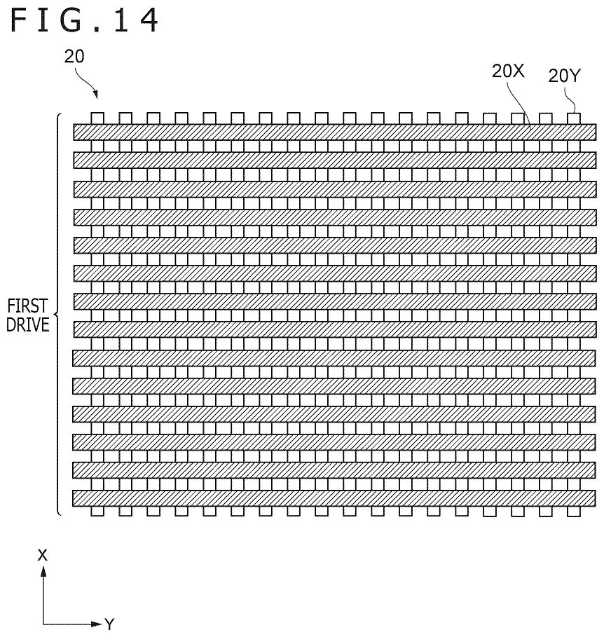

Explained below with reference to FIGS. 14 through 19 are specific examples of the first and second drive operations performed in step SP66 in FIG. 13.

FIG. 14 is a view schematically depicting a drive operation of the sensor controller 22B in a state where a touch is not detected. It is assumed here that, of the sensor electrodes 20X and 20Y making up the touch sensor 20, the sensor electrodes 20X are used as the transmission electrodes (Tx electrodes) and the sensor electrodes 20Y are used as the reception electrodes (Rx electrodes). In a case where a touch is not detected by the touch sensor 20, a uniform drive operation (i.e., first drive operation) is carried out on all applicable sensor electrodes 20X.

FIG. 15 is a view schematically depicting drive operations of the sensor controller 22B in a state where a touch is detected. Specifically, FIG. 15 corresponds to a view having transitioned from the state in FIG. 14 to a state where a touch by the user's hand 18 (e.g., two fingers) is detected. The plurality of sensor electrodes 20X are classified dynamically into two electrode groups in accordance with the positional relation of the touch by the hand 18. Single-hatched sensor electrodes 20X in the illustration are classified into the first electrode group being “touched.” The remaining double-hatched sensor electrodes 20X are classified into the second electrode group being “untouched.” Here, the first drive operation is performed on six sensor electrodes 20X belonging to the first electrode group, and the second drive operation is performed on eight sensor electrodes 20X belonging to the second electrode group.

As a result, upon execution of a single touch scan, the execution frequency of the second drive operation is lower or the execution amount of the second drive operation is smaller than that of the first drive operation. This may lead to a possibility of the performance of touch detection by the second drive operation decreasing. Meanwhile, the power consumption attributable to the specific drive operation is reduced.

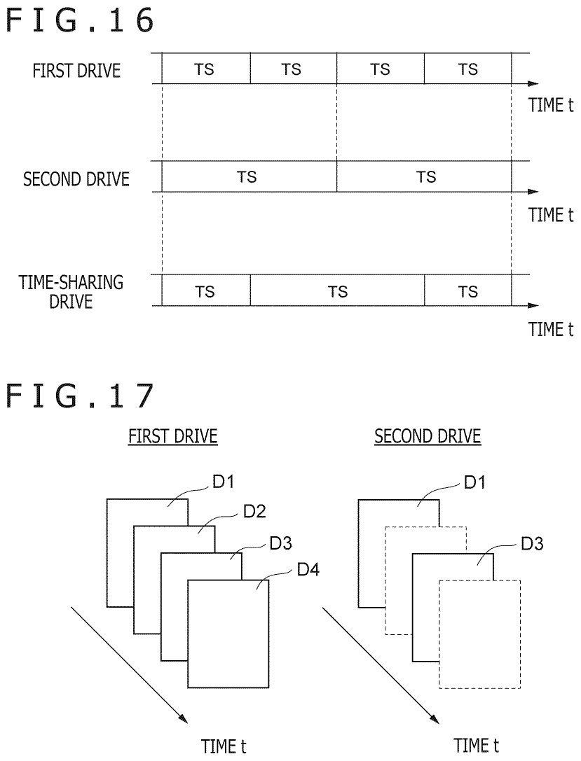

FIG. 16 is a view depicting a first example of differences in behavior between the first drive operation and the second drive operation. In the example in FIG. 16, the first and second drive operations are related to the output process of outputting data, including the detected positions of the hand 18, to the outside. For example, the touch scan (TS) is performed at an output rate of 120 Hz in the first drive operation, and the touch scan (TS) is carried out at an output rate of 60 Hz (half of 120 Hz) in the second drive operation. In this case, the power consumption attributable to the data output process is reduced through the second drive operation. It is to be noted that, although a time responsiveness of the result of detection upon touch slightly decreases in the second drive operation, the second drive operation is switched to the first drive operation immediately after the touch by the hand 18, which minimizes adverse effects on the time responsiveness. It is to be noted that the first and second drive operations may be performed selectively as described above, or may be performed instead on a time-sharing basis.

FIG. 17 is a view depicting a second example regarding the differences in behavior between the first drive operation and the second drive operation. In the example in FIG. 17, the first and second drive operations are related to the statistical process performed on a plurality of sampled values obtained by the touch scan. For example, in the first drive operation, signal distribution data D1 through D4 of four frames are obtained, and a signal distribution (or heat map) averaging the four acquired sampled values is calculated. In the second drive operation, on the other hand, signal distribution data D1 and D3 of two frames are obtained, and a signal distribution averaging the two acquired sampled values is calculated. In this case, the power consumption attributable to the number of samplings are reduced through the second drive operation. It is to be noted that, although there is a statistical dispersion of the result of detection upon touch in the second drive operation, the second drive operation is switched to the first drive operation immediately after the touch by the hand 18, which minimizes adverse effects of the statistical dispersion.

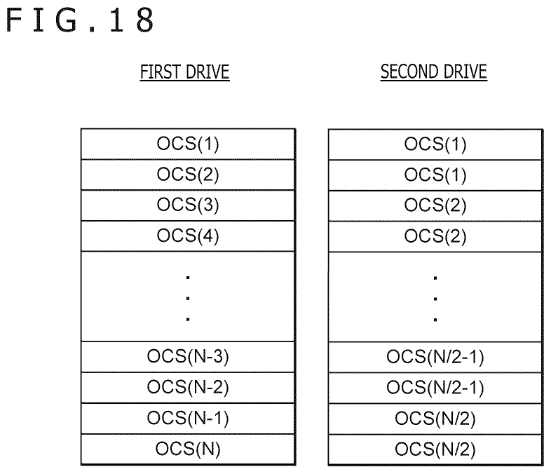

FIG. 18 is a view depicting a third example regarding the differences in behavior between the first drive operation and the second drive operation. In the example in FIG. 18, the first and second drive operations are related to the transmission process of outputting the finger detection signal FDS to the sensor electrodes 20X. For example, in the first drive operation, each sensor electrode 20X is supplied with an orthogonal code sequence OCS, i.e., the sensor electrodes 20X are parallelly supplied with N different orthogonal code sequences. On the other hand, in the second drive operation, every two adjacent sensor electrodes 20X are supplied with a common orthogonal code sequence OCS, i.e., the sensor electrodes 20X are supplied with (N/m) (m=2) different orthogonal code sequences. In this case, the power consumption attributable to the calculation of capacitance values is reduced through the second drive operation. It is to be noted that, although a spatial resolution of the result of detection upon touch slightly drops in the second drive operation, the second drive operation is switched to the first drive operation immediately after the touch by the hand 18, which minimizes adverse effects of the drop in the spatial resolution.

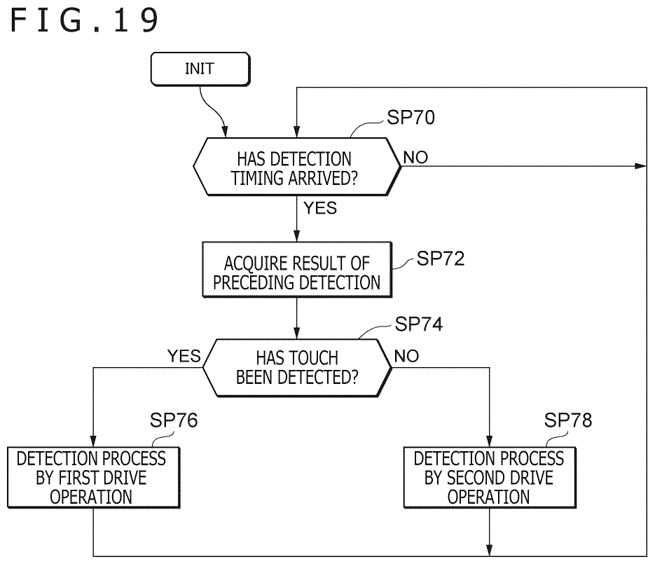

FIG. 19 is a flowchart indicating another example of the detection operation performed by the sensor controller 22B in FIG. 11.

In step SP70, the sensor controller 22B determines whether or not a detection timing has arrived. In a case where a detection timing has yet to arrive (NO in step SP70), the sensor controller 22B remains in step SP70 until a detection timing arrives. On the other hand, in a case where a detection timing has arrived (YES in step SP70), the sensor controller 22B goes to step SP72.

In step SP72, the drive change circuitry 102 acquires the result of detection obtained by the preceding touch scan (i.e., result of the preceding detection).

In step S74, the drive change circuitry 102 determines whether or not a touch by the hand 18 is detected by referencing the result of the preceding detection acquired in step SP72. In a case where a touch by the hand 18 is detected (YES in step SP74), the detection processor 100 goes to step SP76.

In step SP76, the detection processor 100 performs the detection process by the first drive operation in accordance with the first drive parameter. Thereafter, the sensor controller 22B returns to step SP70 and repeatedly executes steps SP70, SP72, SP74, and SP76 when the touch is continuously detected.

Described with reference to step SP74 again, in a case where a touch is not detected (NO in step SP74), the detection processor 100 goes to step SP78.

In step SP78, the detection processor 100 performs the detection process by the second drive operation in accordance with the second drive parameter. Thereafter, the sensor controller 22B returns to step SP70 and repeatedly executes steps SP70, SP72, SP74, and SP78 when the touch is not detected continuously.

In this manner, the sensor controller 22B performs the operation of detecting the pointed position (here, touch position) in real time by repeatedly executing steps SP70 through SP76 in FIG. 19.

### Summary of Second Embodiment

As described above, the electronic device 12 in the second embodiment includes the capacitive touch sensor 20 having the plurality of sensor electrodes 20X and 20Y arranged planarly and the sensor controller 22 or 22B connected to the touch sensor 20. The sensor controller 22B includes the detection processor 100 and the drive change circuitry 102. The detection processor 100 repeatedly executes a touch scan for detecting a passive pointer (here, hand 18) not transmitting any signal. The touch scan includes a specific drive operation, and the drive change circuitry 102 changes the drive parameters regarding the specific drive operation in such a manner that, when the hand 18 is not detected by the touch scan, the execution frequency of the specific drive operation is made lower or the execution amount of the specific drive operation is made smaller than when the hand 18 is detected by the touch scan.

Further, the position detection method of the second embodiment includes an execution step (SP76 and SP78) causing the sensor controller 22B to repeatedly execute the touch scan, including the specific drive operation and a change step of causing the sensor controller 22B to change the drive parameters regarding the specific drive operation in such a manner that, when the hand 18 is not detected by the touch scan, the execution frequency of the specific drive operation is made lower or the execution amount of the specific drive operation is made smaller than when the hand 18 is detected by the touch scan.

As described above, when the hand 18 is detected by the touch scan, the execution frequency of the specific drive operation is caused to be lower or the execution amount of the specific drive operation is caused to be smaller than when the hand 18 is not detected. This makes it possible to spontaneously reduce the power consumption in detecting the pointed position, in a specific state of the touch sensor 20, specifically in the case where the finger 16 is not detected.

Moreover, the drive change circuitry 102 classifies the plurality of sensor electrodes 20X and 20Y constituting the touch sensor 20 into the first electrode group and the second electrode group. The first electrode group is an aggregate of the sensor electrodes 20X and 20Y corresponding to the positions at or close to which the hand 18 is detected, and the second electrode group is an aggregate of the sensor electrodes 20X and 20Y corresponding to the positions at which the hand 18 is not detected. In addition, the drive change circuitry 102 may set, for the first electrode group, the first drive parameter for either making the execution frequency of the specific drive operation relatively high or making the execution amount of the specific drive operation relatively large, and may set, for the second electrode group, the second drive parameter for either making the execution frequency of the specific drive operation relatively low or making the execution amount of the specific drive operation relatively small.

Also, the drive change circuitry 102 may classify, into the first electrode group, of the sensor electrodes 20X and 20Y located at the positions corresponding to values most recently detected by the touch scan, in correlation to the amount of change in capacitance, the detected values exceeding a threshold, and classify into the second electrode group the sensor electrodes 20X and 20Y located at the positions corresponding to the detected values not exceeding the threshold.

Further, the specific drive operation may be related to the output process of outputting data including the detected positions of the hand 18 to the outside. The drive parameters may include the number of outputs per unit time in the output process. In this case, the drive change circuitry 102 may set a relatively large number of outputs as the first drive parameter for the first electrode group, and set a relatively small number of times of output as the second drive parameter for the second electrode group.

Moreover, the specific drive operation may be related to the statistical process performed on a plurality of sampled values obtained by the touch scan. The drive parameters may include the number of samples in the statistical process. In this case, the drive change circuitry 102 may set a relatively large number of samples as the first drive parameter for the first electrode group and set a relatively small number of samples as the second drive parameter for the second electrode group.

In addition, the specific drive operation may be related to the transmission process of outputting the detection signal of the hand 18 to the sensor electrodes 20X and 20Y. The drive parameters may include a plurality of orthogonal code sequences formed by the detection signal. In this case, the drive change circuitry 102 may set a different orthogonal code sequence as the first drive parameter for each of the sensor electrodes 20X and 20Y belonging to the first electrode group and set a common orthogonal code sequence as the second drive parameter for at least two sensor electrodes 20X and 20Y belonging to the second electrode group.

Further, the specific drive operation may be related to the reception process of receiving the detection signal of the hand 18 from the sensor electrodes 20X and 20Y. The drive parameters may include the usage rate of the sensor electrodes 20X and 20Y used in the reception process. In this case, the drive change circuitry 102 may set a relatively high usage rate of the sensor electrodes 20X and 20Y as the first drive parameter for the first electrode group, and set a relatively low usage rate of the sensor electrodes 20X and 20Y as the second drive parameter for the second electrode group.

It is to be noted that the embodiment of the present disclosure is not limited to the foregoing embodiments, and that various changes can be made without departing from the spirit of the present disclosure.

1. A sensor controller connected to a capacitive touch sensor having a plurality of sensor electrodes arranged planarly, the sensor controller comprising:
a scan controller that executes a plurality of types of operation modes, in which a pen scan for detecting an active pen transmitting a downlink signal and a touch scan for detecting a passive pointer not transmitting the downlink signal are repeatedly executed on a time-sharing basis via the plurality of sensor electrodes; and
a signal transmitter that transmits, during execution of the pen scan, an uplink signal for requesting the downlink signal, via the plurality of sensor electrodes,
wherein, when the passive pointer is not detected by the touch scan, the signal transmitter makes a transmission frequency of the uplink signal lower than when the passive pointer is detected by the touch scan.

2. The sensor controller according to claim 1,
wherein the plurality of types of operation modes include:
a first mode in which a time slot for the touch scan is assigned to a first touch time length and a time slot for the pen scan is assigned to a first pen time length, and
a second mode in which a time slot for the touch scan is assigned to a second touch time length and a time slot for the pen scan is assigned to a second pen time length, and
the scan controller selectively executes the first mode when the passive pointer is detected and selectively executes the second mode when the passive pointer is not detected.

3. The sensor controller according to claim 2,
wherein the second touch time length is given by subtracting a predetermined value from the first touch time length, and
the second pen time length is given by adding the predetermined value to the first pen time length.

4. The sensor controller according to claim 3,
wherein, when the number of transmissions of the uplink signal per unit time in the first mode is defined as a first transmission rate and the number of transmissions of the uplink signal per unit time in the second mode is defined as a second transmission rate, a product of the second pen time length and the second transmission rate is smaller than a product of the first pen time length and the first transmission rate.

5. The sensor controller according to claim 1,
wherein the pen scan is a global scan for detecting the active pen over an entire sensor region provided by the touch sensor.

6. The sensor controller according to claim 1,
wherein, when the passive pointer is not detected by the touch scan, the signal transmitter makes:
a transmission voltage of the uplink signal lower,
the number of the sensor electrodes used for transmitting the uplink signal smaller, or
an orthogonal code sequence for encoding the uplink signal shorter, than when the passive pointer is detected by the touch scan.

7. The sensor controller according to claim 1, further comprising:
a signal acquisition circuitry that receives and acquires the downlink signal from the plurality of sensor electrodes during execution of the pen scan,
wherein, when the passive pointer is not detected by the touch scan, the signal acquisition circuitry makes a reception frequency of the downlink signal lower than when the passive pointer is detected by the touch scan.

8. The sensor controller according to claim 1,
wherein, when a specific condition is met, the signal transmitter makes:
the transmission frequency of the uplink signal higher,
a transmission voltage of the uplink signal higher,
the number of the sensor electrodes used for transmitting the uplink signal larger, or
an orthogonal code sequence used for encoding the uplink signal longer, than when the specific condition is not met.

9. The sensor controller according to claim 8,
wherein the specific condition includes:
a condition under which disconnection of at least one of the sensor electrodes is detected,
a condition under which an operation mode for detecting the passive pointer not transmitting the downlink signal is being executed by the scan controller, or
a condition under which an operation mode for detecting the passive pointer in a special state is being executed by the scan controller.

10. The sensor controller according to claim 1,
wherein, when the active pen meets a proximity condition indicative of a state in which the active pen is either close to or in contact with the touch sensor, the signal transmitter either changes a transmission voltage of the uplink signal or changes a length of an orthogonal code sequence used for encoding the uplink signal, in accordance with a tilt angle of the active pen.

11. An electronic device comprising:
a capacitive touch sensor having a plurality of sensor electrodes arranged planarly; and
a sensor controller connected to the touch sensor, the sensor controller including:
a scan controller that executes a plurality of types of operation modes in which a pen scan for detecting an active pen transmitting a downlink signal and a touch scan for detecting a passive pointer not transmitting the downlink signal are repeatedly executed on a time-sharing basis via the plurality of sensor electrodes,
a signal transmitter that transmits, during execution of the pen scan, an uplink signal for requesting the downlink signal, via the plurality of sensor electrodes, and
when the passive pointer is not detected by the touch scan, the signal transmitter making a transmission frequency of the uplink signal lower than when the passive pointer is detected by the touch scan.

12. A position detection method comprising:
using a sensor controller connected to a capacitive touch sensor having a plurality of sensor electrodes arranged planarly;
repeatedly executing, on a time-sharing basis via the plurality of sensor electrodes, a pen scan for detecting an active pen transmitting a downlink signal and a touch scan for detecting a passive pointer not transmitting the downlink signal; and
transmitting, during execution of the pen scan, an uplink signal for requesting the downlink signal, via the plurality of sensor electrodes,
wherein, in the transmitting, when the passive pointer is not detected by the touch scan, a transmission frequency of the uplink signal is made lower than when the passive pointer is detected by the touch scan.

13.-22. (canceled)
